(19) United States
(12) Patent Application Publication
(10) Pub. No.: US 2004/0061873 A1
(43) Pub. Date: Apr. 1, 2004

(54) Method and apparatus for detecting media thickness

(76) Inventor: Brett L. Davis, Boise, ID (US)

Correspondence Address: HEWLETT-PACKARD COMPANY, Intellectual Property Administration, P.O. Box 272400, Fort Collins, CO, 80527-2400, US

(21) Appl. No.: 10/256,123

(22) Filed: Sep. 26, 2002

(51) Int. Cl. G01B 11/28

(52) U.S. Cl. 356/630

(57) ABSTRACT

An apparatus and method for adjusting at least one imaging process in response to the media thickness as detected by a media thickness sensor is presented. The apparatus is an optical sensor for measuring a thickness of a media in an imaging device. The sensor includes a light source and a receiver. The light source transmits a beam toward a first side of the media which reflects at least a portion of the transmitted beam as a reflected beam. The second side of the media is supported by a media support that is a fixed distance from the light source and receiver. The receiver receives the reflected beam and generates output signals correlating the receiver output to a media thickness. The output signals are used to adapt at least one imaging process in response to the measured media thickness.

### BACKGROUND OF THE INVENTION

1. Field of the Invention

This invention relates generally to the measurement of media thickness and, more particularly, to an optical-based system for measuring media thickness.

2. State of the Art

Imaging systems, such as printers, photocopiers and the like, have long been restricted by their abilities to handle a single composition or thickness of media and, as such, have had their imaging processes tuned for that specific type of media. For example, imaging systems were designed for printing or imaging a specific thickness of media, such as paper, with the mechanical feed assemblies and imaging processing being configured for that specific composition or thickness of media. Advancements in imaging systems enabled utilization of a broader spectrum of media types and thicknesses. Differences in media thicknesses were accommodated through broader tolerances or adaptable mechanisms. In addition to the mechanical tolerances associated with such flexible imaging systems, the imaging processes also yielded less desirable results when a single imaging process profile was utilized for the imaging of a broad spectrum of media thicknesses. Therefore, imaging processes also adapted as a result of varying paper thicknesses. Those of skill in the art appreciate that such imaging processes include variations in applied fields as well as variations in fuser timing and inter-page gaps.

Therefore, there was a need for determining a media thickness in such multi-thickness imaging systems. Early approaches for identifying media thickness were based largely on mechanical solutions or contact-based approaches which estimated the thickness of a specific sample of media. Such mechanical approaches encountered various shortcomings including the inaccurate nature of mechanical approaches due to unpredictable and highly variable frictional forces associated with the various mechanical elements of a mechanical paper thickness sensor. Additionally, mechanical approaches, by their contact nature, are inherently slow in both the set-up time required to assert mechanical pressure on the media as well as in the calculation or translation of the sensor's mechanical offset into an imaging process adaptation. Yet an additional shortcoming of mechanical approaches is the contact nature of the sensing process wherein a further physical contacting process encounters the media which may result in media deformities or contamination. Also, with the advancements of electronics and the economic advantages associated with the ubiquitous nature of electronics, mechanical assemblies frequently are more expensive than electronic componentry.

Other sheet thickness sensor approaches have utilized a combination of mechanical and optical approaches wherein a mechanical tracking arm includes an end that mechanically engages with the media being tested while an opposing end is fitted with a mirrored or reflective surface that alters the optical reflective path of an optical sensor. A more detailed description of this technique is found in U.S. Pat. No. 5,806,992.

Due to the mechanically intensive nature of contact-based sensor approaches, noncontact-based approaches have also been developed. Such approaches, however, have focused upon quality control of media manufacturing, namely, monitoring of continuous sheets of materials. As such approaches are based upon the need to continuously monitor the quality of continuous sheets of materials, such approaches are often computationally overly complex and redundantly unnecessary for the sensing of a thickness of a media that has previously undergone stringent manufacturing quality control scrutiny. A more detailed description of this technique is found in U.S. Pat. No. 5,222,729 and U.S. Pat. No. 6,038,028. Moreover, such noncontact manufacturing quality control approaches are economically prohibitive in a mass-produced imaging system environment because of the additional and excessive complexity of multiple sensors and dual-side monitoring of the media under evaluation. Both examples of such an implementation recognize the sagging or unsupported nature of the media, thus requiring a thickness detection sensor on each side of the media to compensate for such migration of the media across the sensor's field of view.

Therefore, for the foregoing reasons, it would be desirable to provide a noncontact media thickness sensor capable of economically performing an evaluation of a media thickness in an imaging system allowing the imaging processes to be modified accordingly, thereby overcoming the limitations of the prior art. It would be further desirable to provide a method for overcoming the aforementioned limitations in the prior art.

### BRIEF SUMMARY OF THE INVENTION

An apparatus and method for adjusting at least one imaging process in response to the media thickness as detected by a media thickness sensor is presented. The apparatus is an optical sensor for measuring a thickness of a media in an imaging device. The sensor includes a light source and a receiver. The light source transmits a beam toward a first side of the media which reflects at least a portion of the transmitted beam as a reflected beam. The second side of the media is supported by a media support that is a fixed distance from the light source and receiver. The receiver receives the reflected beam and generates output signals correlating the receiver output to a media thickness. The output signal is used to control the imaging process, which allows the imaging device to adapt at least one imaging process to the media under test.

The sensor may be integrated into a media thickness sensor system for adapting at least one imaging process in an imaging device, such as a printer or copier or the like, in response to a measured thickness of a media under evaluation and further in preparation for being subjected to the imaging process of the imaging device. The media sensor thickness system includes the optical media thickness sensor, as described above, and sensor control logic which is responsive to the receiver outputs of the sensor receiver. The sensor control logic adapts the imaging process in response to the measured media thickness. Those of skill appreciate the various specific imaging processes that are enhanced due to the tailoring of the imaging processes according to the media thickness.

In one embodiment, the sensor receiver is configured as a photo-resistive array which generates an analog output corresponding to the relative position of the reflected beam on the receiver array. Conversion of the analog position signal into a digital signal facilitates control and correlation of the position data. Therefore, one embodiment integrates an analog-to-digital converter (ADC) for transforming the receiver's analog signal. Additionally, receivers may not be completely linear devices for directly correlating a specific reflected beam position into a corresponding media thickness. Therefore, a calibration table is also presented that facilitates further linearization of the receiver outputs in view of nonlinearities of the system. A second embodiment utilizes a position-sensing detector as the receiver with analog signals as outputs which may be capable of higher throughput processing.

The media thickness sensor system with the included optical sensor may be further integrated into an imaging device, such as a printer or copier or the like. The imaging device, in addition to including the media thickness sensor system, further includes an image processing block or operational imaging portion which is adaptive to the measured media thickness correlated from the receiver outputs.

A method utilizing the sensor of the present invention is presented for adjusting at least one imaging process in response to a measured thickness of a media in an imaging device. The method includes the steps of sensing the media thickness and adjusting the imaging process in response to the sensor's receiver output signals.

Other features and advantages of the present invention will become apparent to those of skill in the art through a consideration of the ensuing description, the accompanying drawings, and the appended claims.

### BRIEF DESCRIPTION OF THE SEVERAL VIEWS OF THE DRAWINGS

In the drawings, which illustrate what is currently considered to be the best mode for carrying out the invention:

FIG. 1 illustrates a block diagram of an imaging device capable of modifying imaging processes in accordance with the media sensing techniques of the present invention;

FIG. 2 illustrates an operational configuration of a media thickness sensor, in accordance with an embodiment of the present invention;

FIG. 3 illustrates an exemplary receiver of a media thickness sensor, in accordance with an embodiment of the present invention;

FIG. 4 is a simplified block diagram of a media thickness sensor system, in accordance with an embodiment of the present invention; and

FIG. 5 is a flowchart illustrating a method for altering imaging processes in an imaging device in response to a detected media thickness, in accordance with an embodiment of the present invention.

### DETAILED DESCRIPTION OF THE INVENTION

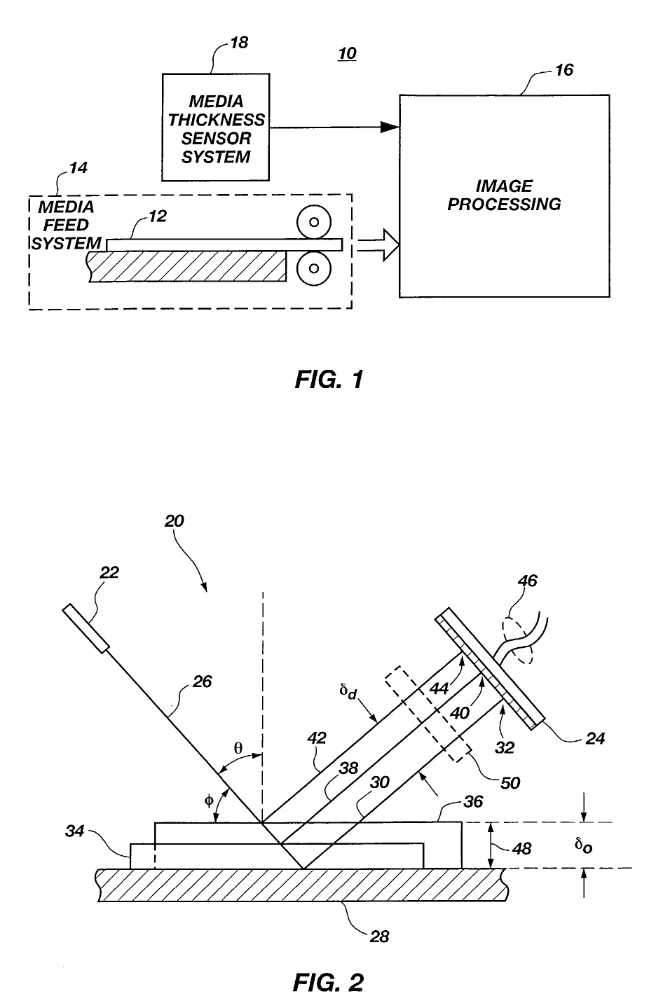

FIG. 1 is a simplified block diagram of an imaging device 10 wherein the media thickness sensing techniques of the present invention may be embodied. Imaging device 10 takes the form of one of several imaging configurations, such as a printer, photo or other electronic copying device, scanning device including a facsimile device, and any and all other configurations that receive a media therein and perform some evaluation or processing of the media. Imaging device 10 may be autonomous or may be further integrated into a larger system and controlled by other peripheral devices. Imaging device 10 performs its intended purpose by receiving or retrieving a media 12 and transporting the media 12 by way of a media feed system 14 to an image processing portion of imaging device 10, illustrated generally as image processing 16. Those of skill in the art appreciate that media feed system 14 performs additional functions such as media alignment and process registration as well as transport of the media from an initial media storage configuration to image processing 16. It should be further appreciated that image processing 16 may perform such functions on the media including the application of printing compounds (e.g., inks) of various forms including laser printing, ink spraying or jetting, and impact printing.

Imaging device 10 further comprises, in accordance with the present invention, a media thickness sensor system 18 for performing a media thickness evaluation on media 12, preferably, in advance of image processing upon media 12. In a preferred configuration, media thickness sensor system 18 is embodied within imaging device 10 in a temporal arrangement occurring prior to the subjection of image processing 16 upon media 12. Such a configuration allows the media thickness characteristic, as derived in media thickness sensor system 18, to become available to image processing 16, thereby allowing sufficient time for adaptations, where necessary, to be performed within image processing 16.

FIG. 2 illustrates a media thickness sensor for use within media thickness sensor system 18 (FIG. 1). In a preferred embodiment, media thickness sensor 20 uses a triangulation method for measuring the thickness of a media. Media thickness sensor 20 is preferably comprised of a light source such as a laser diode 22 which is cooperatively coupled with a receiver 24 for implementation of triangulation techniques. As discussed earlier, media thickness sensor 20 is preferably located in or near a media feed system 14 (FIG. 1) wherein the media is transported to an imaging process. Media thickness sensor 20 operates independently of the media direction, meaning the orientation of laser diode 22 and receiver 24 may be oriented either in parallel with the direction of flow of the media or may also be deployed in a perpendicular relationship to the directionality of the media.

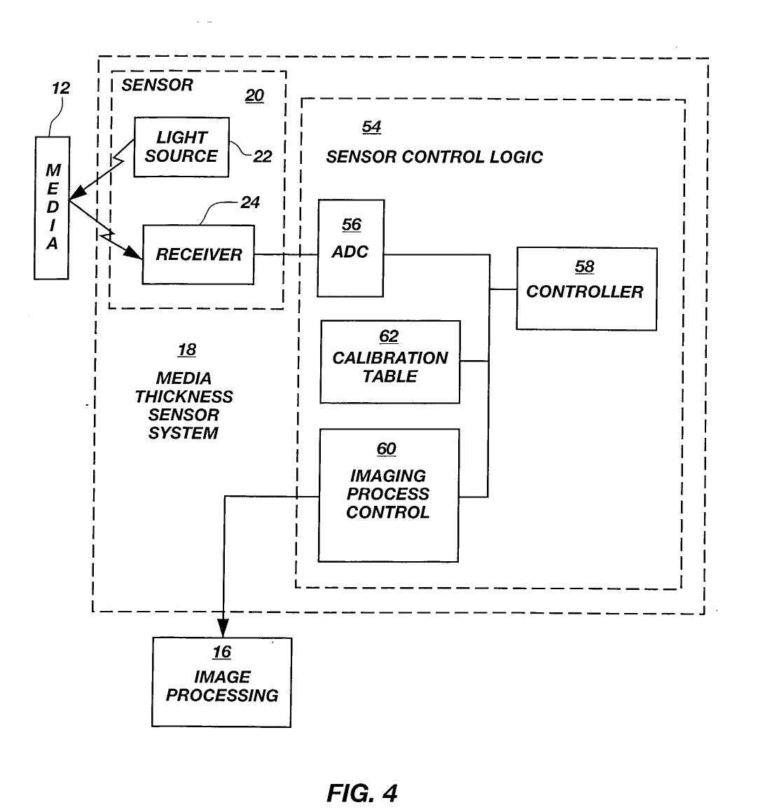

Laser diode 22 produces a beam 26 which is directed at an angle θ onto the targeted surface. During an operational configuration, laser diode 22 transmits a beam 26 toward a media support 28. Media support 28, in the absence of any intervening media, reflects beam 26, illustrated as reflected beam 30, onto a location 32 of receiver 24. Receiver 24, through the computational cooperation of the other operational components of media thickness sensor system 18 (FIG. 4), generates a calibration baseline upon which media thicknesses may be determined.

FIG. 2 illustrates two medias 34 and 36, which are both illustrated by way of superimposition in FIG. 2 for brevity and illustrative purposes only. It should be appreciated that only one of medias 34 and 36 would be present during an evaluation of the media thickness. By way of illustration, a lesser thickness media 34 creates a reflected beam 38 when illuminated by beam 26 of laser diode 22. Reflected beam 38 impinges upon receiver 24 at a location 40 which, once subjected to the computational processing of the other support components of media thickness sensor system 18, results in a measured media thickness associated with media 34. Similarly, in the presence of an enhanced thickness media 36, beam 26 is reflected by media 36 and is illustrated as reflected beam 42 impinging upon receiver 24 at a location 44.

Functionally, beam 26 is focused on the surface of a media, for example media 36, with at least a portion of the light being scattered from the surface of media 36 and reflected at a known angle (d to form a spot upon receiver 24. The relative location of the spot on receiver 24 results in a resistance which varies according to the location and is readily available from receiver 24 via receiver outputs 46. Changes in the distance between the media sensor, namely laser diode 22 and receiver 24, and the surface of the media, for example media 36, results in a corresponding change in the position of the location, location 44 in the present example, on receiver 24. The relationship between the thickness of, for example, media 36 is illustrated as thickness 48 and is defined by the following formula:

For all cases 0°<Φ<90°

$$sin Φ = \frac{{δ}_{0}}{{δ}_{d}}$$

$$media thickness = {δ}_{0} \frac{{δ}_{d}}{2 cos Φ}$$

where δ₀ equals the displacement or thickness of the media;

δ_{d} is the distance of the reflected beams from each surface of the media under evaluation;

and Φ is the angle between the transmitted beam and the surface of the media under evaluation.

By way of example, the thickness of the media is calculated trigonometrically with accuracies and distant or thickness resolution of about 0.01%. Other enhancements may also be implemented such as the utilization of pulsed laser diodes for improved performance in motional environments such as fast-moving media or for vibrational motion components in an otherwise harsh environment. Additionally, modulation of the light source may also be utilized to eliminate the effects of stray or background light but could unfairly bias the identification of the spot or centroid location on receiver 24 as generated to receiver outputs 46. Additionally, optics may be further integrated such as illustrated by optics 50 to further focus or spatially diversify the reflected beams.

In a second embodiment, receiver 24 may be implemented as an analog receiver configured as a PSD (Position Sensing Detector). In one example, a PSD provides two analog signals as outputs corresponding to the relative position of the reflected beam on the receiver array. Conversion of the analog position signals into a digital signal facilitates control and correlation of the position data. Therefore, one embodiment integrates two analog-to-digital converters (ADC) for transforming the receiver's analog signals. Additionally, receivers may be implemented as semilinear devices for indirectly correlating a specific reflected beam position into a corresponding media thickness. Therefore, a calibration table is also contemplated that facilitates further linearization of the receiver outputs in view of nonlinearities of the system.

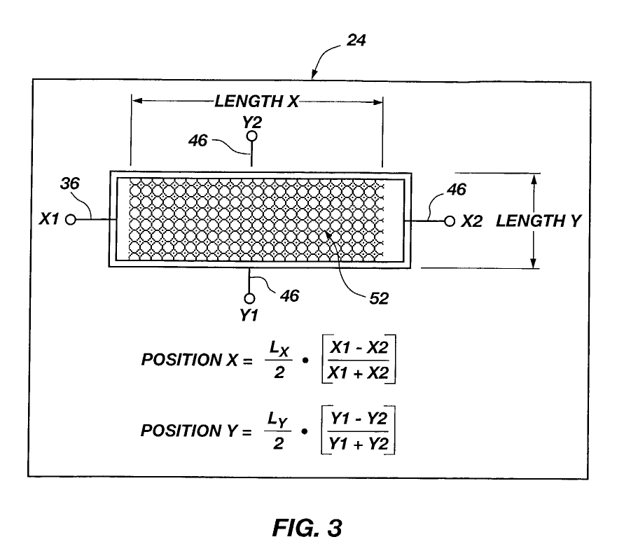

FIG. 3 illustrates a receiver 24 capable of being integrated within a media thickness sensor, in accordance with an embodiment of the present invention. In the present invention, a receiver functions by gathering the light reflected off of the media and images the light onto an array of receiver elements. The receiver then determines the relative location of the concentration of the reflected beam through receiver outputs.

In the present invention, receiver 24 has a photo-resistive array capable of varying the resistance exhibited in receiver outputs 46 according to the migration of the reflected beam location across the range of the array. In one implementation, the photo-resistive array is implemented as a position-sensing detector (PSD) which may be implemented as an opto-electronic device for converting an incident light spot into continuous position data. Such a device provides acceptable resolution for small profile or thickness monitoring such as the monitoring of the thickness of media. Additionally, such an implementation further provides response times and linearities which are acceptable for the present application and embodiment. It should be appreciated that receiver 24 of the present invention may be implemented either as a single dimensional array or as a two-dimensional array. By way of example, a one-dimensional PSD detects a reflected beam location moving over a surface in one dimension (i.e., a straight line). In such devices, a photoelectric current is generated by the incident light and can be seen as an input bias current divided into two output currents, Y₁ and Y₂. The relationship between these output currents results in the reflected beam location utilizing the formula:

$$Position = \frac{L}{2} \cdot \frac{{Y}_{1} - {Y}_{2}}{{Y}_{1} + {Y}_{2}}$$

where L is equal to the length of the PSD.

FIG. 3 specifically illustrates a two-dimensional PSD with receiver elements depicted generally as element 52. In an embodiment of receiver 24 utilizing a two-dimensional PSD, the receiver is capable of detecting a light spot moving over its surface in two dimensions. A photoelectric current is generated by the incident light at a reflected beam location and is determinable by utilizing two input currents, X₁ and X₂, and two output currents, Y₁ and Y₂. The relationship between the currents gives the reflected beam location through the formulas:

$$Position Y = \frac{{L}_{Y}}{2} \cdot \frac{{Y}_{1} - {Y}_{2}}{{Y}_{1} + {Y}_{2}}$$

$$Position X = \frac{{L}_{X}}{2} \cdot \frac{{X}_{1} - {X}_{2}}{{X}_{1} + {X}_{2}}$$

where, L_{Y} and L_{X} are equal to the length of the PSD in the Y and X dimensions, respectively. With these equations, the separation of the dimensions improves the linearity associated with receiver 24.

While receiver 24 has been described herein as a photo-resistive array, namely a PSD implementation, other array configurations are contemplated within the present invention. Such devices further include addressable arrays wherein the centroid or reflected beam location is not calculated by the sensor but rather is calculated by signal processing techniques integrated within a controller which specifically address each of the elements of the array and assembles the aggregate array elements for processing.

FIG. 4 is a simplified block diagram of the media thickness sensor system integrating a media sensor, in accordance with an embodiment of the present invention. Media thickness sensor system 18 is comprised of media thickness sensor 20, described previously, and sensor control logic 54. Sensor control logic 54 couples to media thickness sensor 20 to provide the associated processing of a reflected beam location into an identified media thickness for adaptation of imaging processes and adaptation of other controls within the imaging device.

Sensor control logic 54 is comprised of an A-to-D converter (ADC) 56 which electrically and operationally couples to receiver 24 through the respective quantity of interfaces corresponding to the dimensionality of receiver 24. ADC 56 converts the analog signals from receiver 24 into digitally formatted signals for use by executional logic in the adaptation processes described above. ADC 56 further couples to a controller 58 which, in one embodiment, is implemented as a portion of the available bandwidth of an imaging device microprocessor or other host or control elements.

Sensor control logic 54 is further comprised of imaging process control 60, which may be implemented as executional logic interfaced with control capability for modifying or adapting the performance of image processing 16. Imaging process control 60 may take the form of executable software or, alternatively, may be implemented as analog or digital logic bearing influence on image processing 16. In the presence of nonlinearities associated with the specific capabilities of receiver 24, a calibration table 62 may optionally be incorporated to rectify the nonlinearities and provide a more linearized media thickness measurement.

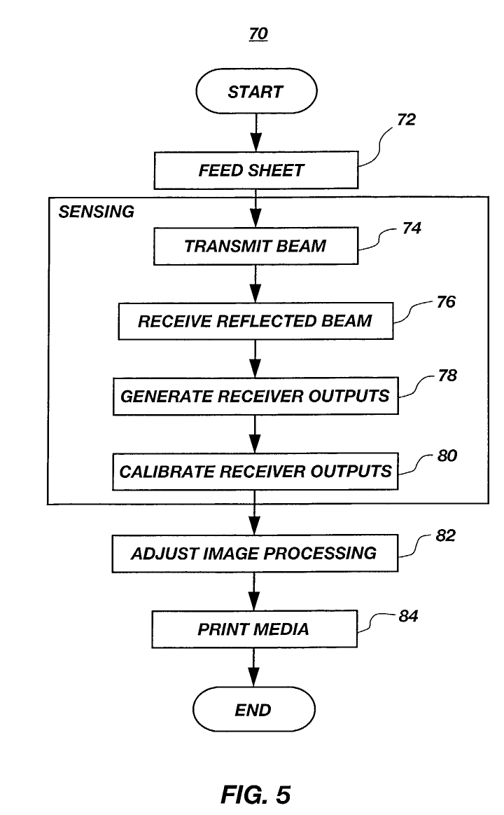

FIG. 5 is a flow chart illustrating a method for adjusting at least one imaging process in response to a measured thickness of the media in an imaging device, in accordance with an embodiment of the present invention. While the present illustrated method is drawn to a printer and a printing process, copying processes and other media processes are also contemplated within the scope of the presently illustrated method.

In method 70, a step 72 feeds a single piece of media into the transport system such as media feed system 14 (FIG. 1). Step 72 may include additional steps including retrieving the single sheet of media from a media storage bin or from a single feed mechanism. Step 72 further includes steps for aligning the media as well as mobilizing the media to come in contact with a media support 28 (FIG. 2), thereby allowing a single light source sensor configuration.

Method 70 further includes a series of steps, namely steps 74-80 which are generically known as a sensing step. In step 74, a light source transmits a beam toward the media under evaluation. The light source transmits a coherent beam and is preferably implemented as a laser diode. The transmitted beam may include additional coding to identify the specific beam including modulation or other selectivity approaches. At least a portion of the transmitted beam is reflected off of the first side of the media. A step 76 receives the reflected beam at a receiver. In a preferred implementation, the receiver is a photo-resistive array that generates, in a step 78, a location-representative resistance corresponding to the location of the reflected beam. The resistance, also known as a resistive component, is used to identify a location of the reflected beam on the receiver. The location corresponds to differing angles of reflection corresponding to the media thickness-varying height of the reflective surface of the media.

In an improved attempt to minimize nonlinearities associated with the receiver components, a calibration step 80 modifies the receiver outputs to more accurately reflect the actual thickness of the media. It should be appreciated that in the illustrated embodiments of the previous figures, the receiver outputs are represented as analog signals that undergo an analog-to-digital conversion. Therefore, the calibration step 80 is preferably performed on the digital signal.

A step 82 adjusts the imaging process or processes of the imaging device according to the measured thickness of the media. Those of skill in the art appreciate the various variable printing parameters that, when specifically adapted to a media thickness, result in improved imaging. By way of example, such parameters include the electrical fields associated with the application of toner onto the media as well as the fuser temperature for bonding the toner onto the media. Additional parameters include interpage gaps and other processes for application and bonding of imaging materials onto the media which occurs in a print media step 84.

While the present illustrations contemplate a printing or photocopying environment, the media thickness sensor also finds application to the scanning of images already on the media. For example, derivation of a media thickness in a scanning device enables the mechanical modifications of feed and tracking mechanisms as well as the adjustments to the scanning light intensity.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as described in the claims.

What is claimed is:

1. An optical sensor for measuring a thickness of a media in an imaging device, comprising:
a light source for transmitting a beam toward a media having a first side for reflecting at least a portion of said beam as a reflected beam and a second side directly adjacently supported by a media support,
said media support for rigidly coupling with said light source; and
a receiver for receiving said reflected beam and generating receiver outputs correlating with said thickness of said media, said receiver outputs for adaptation of at least one imaging process to be subjected on said media.

2. The optical sensor, as recited in claim 1, wherein said light source is a laser diode operably capable of transmitting said beam toward said media.

3. The optical sensor, as recited in claim 1, wherein said receiver is a photo-resistive array operably capable of generating at least one resistive component for identifying a location of said reflected beam on said receiver.

4. The optical sensor, as recited in claim 3, wherein said photo-resistive array is arranged as a one-dimensional array.

5. The optical sensor, as recited in claim 3, wherein said photo-resistive array is arranged as a two-dimensional array.

6. The optical sensor, as recited in claim 1, wherein said receiver is an addressable array operably capable of generating a value denoting the presence of said reflected beam on said receiver for each element of said addressable array when addressed.

7. A media thickness sensor system for adapting at least one imaging process in an imaging device in response to a measured thickness of a media to undergo said at least one imaging process, said system comprising:
an optical media thickness sensor for measuring a thickness of said media, including:
a light source for transmitting a beam toward a media having a first side for reflecting at least a portion of said beam as a reflected beam and a second side directly adjacently supported by a media support, said media support for rigidly coupling with said light source; and
a receiver for receiving said reflected beam and generating receiver outputs correlating with said measured thickness of said media, said receiver outputs for adaptation of at least one imaging process to be subjected on said media; and
sensor control logic operably coupled to said optical media thickness sensor and responsive to said receiver outputs for adapting said at least one imaging process in response to said measured thickness of said media.

8. The media thickness sensor system, as recited in claim 7, wherein said sensor control logic comprises an analog-to-digital converter operably coupled to said receiver outputs, said receiver outputs outputting an analog receiver signal and said analog-to-digital converter converting said analog receiver signal into a digital receiver signal corresponding to said measured thickness of said media, said digital receiver signal adapting said at least one imaging process in said imaging device.

9. The media thickness sensor system, as recited in claim 8, wherein said sensor control logic comprises a calibration table operably coupled with said digital receiver signal to remove nonlinearities associated with correlation of said receiver outputs to said measured media thickness.

10. The media thickness sensor system, as recited in claim 7, wherein said sensor control logic comprises imaging process control operably coupled with said receiver outputs to adapt said at least one imaging process of said media in response to said measured thickness of said media.

11. The media thickness sensor system, as recited in claim 7, wherein said light source is a laser diode operably capable of transmitting said beam toward said media.

12. The media thickness sensor system, as recited in claim 7, wherein said receiver is a photo-resistive array operably capable of generating at least one resistive component for identifying a location of said reflected beam on said receiver.

13. The media thickness sensor system, as recited in claim 12, wherein said photo-resistive array is arranged as a one-dimensional array.

14. The media thickness sensor system, as recited in claim 12, wherein said photo-resistive array is arranged as a two-dimensional array.

15. An imaging device, comprising:
a media thickness sensor system, said system comprising:
an optical media thickness sensor for measuring a thickness of a media, including:
a light source for transmitting a beam toward a media having a first side for reflecting at least a portion of said beam as a reflected beam and a second side directly adjacently supported by a media support, said media support for rigidly coupling with said light source; and
a receiver for receiving said reflected beam and generating receiver outputs correlating with a measured thickness of said media; and
sensor control logic operably coupled to said optical media thickness sensor and responsive to said receiver outputs; and
image processing operably coupled to said sensor system, said image processing adaptive to said measured media thickness as correlated to said receiver outputs.

16. The imaging device, as recited in claim 15, wherein said receiver is a photo-resistive array operably capable of generating at least one resistive component for identifying a location of said reflected beam on said receiver.

17. The imaging device, as recited in claim 15, wherein said sensor control logic comprises an analog-to-digital converter operably coupled to said receiver outputs, said receiver outputs outputting an analog receiver signal and said analog-to-digital converter converting said analog receiver signal into a digital receiver signal corresponding to said measured thickness of said media, said digital receiver signal adapting at least one imaging process in said imaging device.

18. The imaging device, as recited in claim 17, wherein said sensor control logic comprises a calibration table operably coupled with said digital receiver signal to remove nonlinearities associated with correlation of said receiver outputs to said measured media thickness.

19. A method for adjusting at least one imaging process in response to a measured thickness of a media in an imaging device, comprising the steps of:
sensing said measured thickness of said media by an optical sensor installed in a media feed system of said imaging device, said measured thickness being sensed by said optical sensor when installed to reflect a beam from a first side of said media onto a receiver, said receiver having receiver outputs with signals corresponding to said measured thickness of said media, a second side of said media directly adjacently supported by a media support; and
adjusting according to said signals of said receiver outputs said at least one imaging process as correlated to said measured thickness of said media.

20. The method, as recited in claim 19, wherein said sensing step comprises the steps of:
transmitting said beam toward said first side of said media to reflect at least a portion of said beam as a reflected beam;
receiving said reflected beam at said receiver at a location on said receiver correlated to said measured thickness of said media; and
generating signals of said receiver outputs identifying said location on said receiver of said reflected beam corresponding to said measured thickness of said media.

21. The method, as recited in claim 20, wherein said generating step comprises generating at least one resistive component as said signals of said receiver outputs, said at least one resistive component to identify said location of said reflective beam on said receiver.

22. The method, as recited in claim 21, wherein said generating step further comprises calibrating said receiver outputs from said receiver to remove nonlinearities associated with correlation of said signals from said receiver outputs to said measured media thickness.
